(19) United States
(12) Patent Application Publication
(10) Pub. No.: US 2023/0403556 A1
(43) Pub. Date: Dec. 14, 2023

(54) REMOTE WI-FI PROTECTED SETUP FOR JOINING A WI-FI NETWORK

(71) Applicant: SYSTECH CORPORATION, Escondido, CA (US)

(72) Inventors: Anderson WIESE, San Diego, CA (US); La Vaughn Ferguson WATTS, Jr., Cedar Park, TX (US)

(21) Appl. No.: 18/038,366

(22) PCT Filed: Dec. 3, 2021
(86) PCT No.: PCT/US2021/061852

§ 371 Date: May 23, 2023

Related U.S. Application Data
(60) Provisional application No. 63/121,145, filed on Dec. 3, 2020.

(51) Int. Cl. H04W 12/069; H04W 12/50

(52) U.S. Cl. CPC H04W 12/069; H04W 12/50

(57) ABSTRACT

The systems and methods provide the ability to physically access just the AP SSID device and remotely join the Client device to the AP SSID without knowing the SSID or password. This allows for the installer (the owner, a technical installer, service personnel, or novice) to install one or more devices to the desired SSID using the industry standard protocol for WPS. This is especially useful for unattended devices like extenders, bridges, routers, gateways, etc.

### CROSS-REFERENCE TO RELATED APPLICATIONS

The present application claims priority to U.S. Provisional Patent App. No. 63/121,145, filed on Dec. 3, 2020, which is hereby incorporated herein by reference as if set forth in full.

### TECHNICAL FIELD

The embodiments described herein are generally directed to systems and methods for remotely joining a Wi-Fi network.

### BACKGROUND

Remote Wi-Fi Protected Setup (WPS) is currently not defined or available with the standard procedures for pairing or joining devices to a Wi-Fi network.

For conventional WPS methods, when a new device needed to join or become a member of an existing Wi-Fi network, the Wi-Fi joining procedure provided either protected or unprotected (open) processes to join the network. The protected or unprotected process was defined as either the network (SSID, Service Set Identifier)) was password protected or not (open). Various degrees of protection might be available for the password.

The Industry developed a procedure of using a WPS “key” or “button” (collectively referred to as a button) to initiate the process from a device. Once initiated, the other device is required to perform an acceptance or acknowledgement such that they can begin the exchange of information between them.

An example of a simple user scenario begins with an “Access Point” (AP) which can be a home router, gateway, bridge, or switch (many different names used for such a device) that contains a wireless network with Wi-Fi protocols that provides a communication path to all the devices on the network.

In computer networking, a wireless access point (WAP), or more generally just access point (AP), is a networking hardware device that allows other Wi-Fi devices to connect to a wired network. The AP usually connects to a router (via a wired network) as a standalone device, but it can also be an integral component of the router itself. An AP is differentiated from a hotspot which is a physical location where Wi-Fi access is available.

The AP identifies the network services set or group of wireless devices as the service set provider via a named SSID. The SSID could be common or unique and hidden vs broadcast. All devices or members of the SSID provide the same password to become a member of this set of network services. For example, in IEEE 802.11 wireless local area networking standards (including Wi-Fi), a service set (also known as extended service set or ESS) is a group of wireless network devices which are identified by the same SSID (service set identifier).

A “Client device” can be a wireless device like a smart Tv, smartphone, tablet, laptop/notebook computer, desktop computer, unattended device like a gateway or bridge, and other wireless client devices need to join the wireless network established by the AP. These generally are referenced as IEEE 802.11 network devices that are members of an AP with a specified SSID and the common password for that SSID. IEEE 802.11 is part of the IEEE 802 set of LAN protocols, and specifies the set of media access control (MAC) and physical layer (PHY) protocols for implementing wireless local area network (WLAN) Wi-Fi computer communication in various frequencies, including but not limited to 2.4 GHz, 5 GHz, and 60 GHz frequency bands. It should be understood that use of the term “Wi-Fi” herein is not to be construed as being limited to any one specific LAN protocol. Wi-Fi is used herein to generally refer to wireless networks and a facility allowing computers, smartphones, or other devices to connect to the internet or communicate with one another wirelessly within a particular area.

A common AP may generate multiple SSIDs and each SSID may be unique or common. A common SSID may exist on multiple APs and multiple channels within a AP. Some devices may “hop” from one channel to another and some client devices may “hop” between SSIDs as needed, but independent of that, the joining process that this learning is providing is transparent to the actual operation after the devices have authenticated and joined a SSID.

The current methods require a person to access the equipment which includes not only the client device needing to join the AP's SSID but also the physical AP device itself. This can present special problems in the real world. The home environment is an easy background against which to explain the pit falls of operational methods with the current methodology for joining an SSID. The enterprise, office, and industrial workspace is even more forbearing and loaded with opportunities for failures. Given a home environment, the home AP device must be located and accessible since the procedure requires the AP to initiate the SSID joining request. This is accomplished by the person pressing, touching, or activating something physical on the AP device. Generally, it is referenced as the “WPS button” on the router (home gateway, etc.). There are various requirements for this pressing, touching, etc. that are defined for the actual AP device such as how long the touch or press must be or not be for example. Once the button is pressed per the instructions for the AP device, the WPS procedure is activated. Then the person must move to be in physical contact with the client device needing to join the SSID. That client device also contains a WPS button (it might be a key, touch screen, remote control like a TV, etc.) which must be pressed to acknowledge or confirm the WPS request. This pressing of the button on the client device provides the proof of authorization for the device to join the SSID. The physical access to both the AP and the client device provides the security or authorization to access the network.

Given the above scenario, the authorization to access the SSID is valid without knowing the SSID password. An exchange of information between the AP SSID and Client device allow the network functions without the person having to know the password or SSID information for either device (AP or Client device). This makes the network joining process extremely easy for some installations. There are many benefits to this method but also many drawbacks. One of the critical issues is how long does the SSID request from the AP SSID stay valid? If it is a very short period of time (even 5 minutes can be short if trying to walk or access the other device from a distance), the time may expire before the person presses the Client device WPS button to authorize the information exchange. Add to that the lack of user or network status information, the person may not be able to understand exactly where or why the network was not joined successfully by the Client device.

Not all devices support a WPS button or they may not be configured in such a way to enable easy joining or joining at all. Even when a device such as a smart TV may wish to join an AP SSID, the natural perception is that will be easy since the TV has a display and a remote controller. Examining a scenario such at this would require either the TV to have an application displaying on the screen with instructions for the person to go to the AP with the SSID and press the WPS button. Once the button is pressed, the person must return to the TV and view the “access code” (usually 4-6 alpha/numeric) such that they can be input via the remote control on the TV. Again, the time expiration period is of concern along with information needing input via a person at the location of the Client device (TV). Alternatively, since the TV has a display, ability to run an application, and a remote control, the application could scan for AP SSIDs and allow the person to select or input the desired SSID along with the password. This of course assumes the person knows these values.

### SUMMARY

Many different User Scenarios can be defined for how a process for remote wi-fi protected setup for joining a wi-fi network is initiated and completed. However, the base procedure is to initiate the request on one device, acknowledge the request on another device, and then the two devices exchange information to accept the new device into the network using pre-defined protocols. Embodiments described herein can utilize existing communication protocols (e.g., the IEEE 802.11 protocols) to provide an alternative method to allow an unattended client device to become a member of a SSID eliminating some of the operational issues within the current acceptable methods.

Embodiments herein provide methods to be used within the industry as common practice, which may be alternative to the interactive selection of joining AP SSIDs as described above.

In one aspect of embodiment herein a method for remote Wi-Fi protected setup for allowing a client device to join a Wi-Fi network via an access point (AP) without a user having access to the client device includes: activating an application in a master device; the activated application causing the master device to transmit instructions to the client device to initiate a Wi-Fi protected setup procedure; in response to the instructions, executing, at the client device, the Wi-Fi protected setup procedure including establishing a connection with the AP; and the client device communicating a status message to the master device indicating the status of the connection between the client device and the AP.

In another aspect, the client device includes a button to initiate the Wi-Fi protected setup procedure and the instructions to the client device include instructions to an application on the client device to simulate via software the pressing of the button on the client device.

In a further aspect, the method includes displaying the status message on a display of the master device and the status message indicates whether the connection was successful or failed.

In a further aspect, a wireless client device includes a radio transceiver; and one or more processors in communication with the radio transceiver and operable to receive instructions from a master to initiate a Wi-Fi protected setup (WPS); in response to the instructions, executing the WPS including establishing a connection with an AP; and the client device communicating a status message to the master device indicating the status of the connection between the client device and the AP.

In a further aspect, the wireless client includes a button to initiate the WPS and the instructions to the client device include instructions to the client device to simulate via software the pressing of the button on the client device.

In a further aspect, the wireless client device includes an application which when executed by the one or more processors creates an entry point at the WPS button that is branched into by an API, which can be called in response to the instructions from the master device and the one or more processors then execute the software that would otherwise be executed in response to the physical pressing of the button.

In a further aspect, the wireless client device includes means for communicating with the master device with a first communication protocol and means for communicating with the AP with a second communication protocol.

In a further aspect, a method for remote Wi-Fi protected setup (WPS) for allowing a client device having a WPS and a WPS button join a Wi-Fi network via an access point (AP SSID device) through the use of a master device without a user having access to the client device, includes: transmitting, from the master device, instructions to the client device to execute the WPS; after the client device receives the instructions, simulating, at the client device, the pressing of the WPS button; in response to the simulated pressing of the WPS button, the client device initiates and completes the WPS with the AP; and transmitting from the client device to the master device a status message indicating the status of the connection between the client device and the AP. In another aspect, the master device wirelessly communicates with the client device using the Bluetooth protocol and the client device wirelessly communicates with the AP device using a Wi-Fi protocol.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 is a block diagram of system according to embodiments described herein;

FIG. 2 is a flow chart of an example method in accordance with the embodiments herein;

FIG. 3 is a schematic message diagram in accordance with the embodiments herein; and

FIG. 4 is a functional block diagram illustrating an example wired or wireless processing device.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

One aspect of embodiments described herein is the ability to physically access just the AP SSID device and remotely join the Client device to the AP SSID without knowing the SSID or password. This allows for the installer (the owner, a technical installer, service personnel, or novice) to install one or more devices to the desired SSID using the industry standard protocol for WPS. This is especially useful for unattended devices like extenders, bridges, routers, gateways, etc.

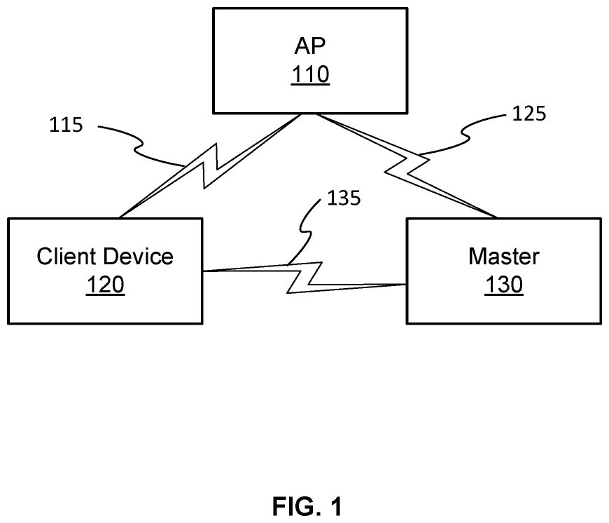

Referring to FIG. 1, embodiments described herein include providing the person (e.g., a user) with a master device 130 (such as a smart phone, tablet, smart wearable devices, personal computer, or the like). The master device 130 is used as an information and data input device not related to either the AP SSID device 110 (or simply the AP) or the Client device 120 (or simply the client device) which has the ability to accept instructions from the master device 130. The master device 130 may or may not be part of the joined AP SSID nor even be connected to an outside or internal network. However, the master device 130 should be able to connect to the Client device via a wireless or wired connection 135. Generally, this connection is an alternative connection such as Bluetooth or Ethernet. Alternative communication connections could be Zigbee or Z-Wave or even simple RF (e.g., NFC or other RF based communication protocols). There may even be an intermediate bridge between the Client device and the master device 130 such as a Z-Wave to Bluetooth bridge providing the connection 135 to the Client device and the master device 130 via alternative wireless connections. The Client device 120 should accept commands from a master device 130 (e.g., the smart device) to “simulate the pressing of the WPS button” via a software command. A non-limiting illustrative example is a user interface generated on a screen of the master device 130 that generates a display of a visualization of a “button” that the user may press. That results in the master device 130 sending the command to the client device. This user interface can be driven via a web based application (e.g., an Amazon® Web Service (AWS) or other on-demand cloud computing platform services) or an application running locally on the master device 130 (e.g., an iOS® application, Android® application, and the like), etc. The simulated pressing of the “button” on the customer device in response to the command from the master device 130 can be accomplished via a software application (the client device application) within the client device 120 (e.g., the gateway). For example, software running on the client device 120 simulates the pressing of the key once the application on the client device 120 receives the command from the master device 130 (e.g., in this case the master 130 can be any computing device such as an iPhone, iPad, Android, AWS applications, Windows 10, Linux, etc. application). This allows the standard protocol within the Client device 120 to perform the industry standard protocol authentication process with the AP SSID device 110 without the person physically being at the Client device 120. A more detail explanation of this process is provided below.

The master device 130 establishes a connection 135 to the Client device 120 (wireless or wired as discussed above) such that commands, status and information may flow between the logic within the Client device 120 and the master device 130.

The master device 130 uses the device display and touch as human interfaces for information exchange, instructions, status feedback and general communication such as help screens, option screens, and installation procedure documentation to name a few.

This embodiment provides a hybrid method of using the WPS button on the AP SSID device 110 and the master device 130 to allow the Client device 120 to join the indicated SSID without physically touching or accessing the Client device 120, knowing the SSID or knowing the password for the SSID. The installer activates the application (the master device application) within the master device 130 either before or after pressing the WPS button on the AP SSID device 110. The master device 130 may communicate with the Ap SSID device 110 (represented by communication link 125), for example, using the application running on the master device 130 to acquire information from the AP SSID device 110 that can be used in instructing the client device 120.

In another example, if the AP SSID device 110 is connected to the master device, then acquiring information from the AP SSID device 110 may already be completed. Thus, the only task left may be to talk to the client device 120 to instruct the simulation of pressing the button or key. The master device 130 can talk (communicate with) to the application on the client device 120 via Bluetooth or other wired or wireless communication protocol, for example, to be instructed to “press” the button. In that case, the application on the master device 130 does not need to talk to the AP to get information, everything was transparent. In various embodiments, it may be preferable to activate the application prior to pressing the WPS key since that would allow for a known good connection to the Client device 120 before initiating a WPS join request. Assuming the application is already activated and made the connection 135 to the Client device 120, the installer is instructed to press the WPS button on the Ap SSID device 110. The master device 130 then informs the Client device 120 (via communication link 115) to execute as if the WPS button on the Client device 120 was pressed (could be a virtual button on Client device 120) thus activating the industry standard WPS procedure and exchanging information. The Client device 120 will communicate information to the master device 130 as the joining process continues with real-time as possible status updates for the installer. A status of connection successful or failed can be given to the installer via the master device 130 along with any pertinent information. The status of the connection may be provided by either of the client device 120 and/or the AP SSID device 110.

As an example, an API may be installed on the client device 120 (for example, where the client device 120 is a gateway, a SysSCRIPT API may be installed). The WPS code within the client device 120 may be executed as if there was a physical button and it was pressed by creating an entry point at the WPS service button or key that is branched into by the API at the client device 120, which can be called from the application on the master device 130. The entry point may execute the code that would otherwise be executed for the physical pressing of the button/key and return status via the API to the calling application. Generally, software developing kits (SDK) for software developers are provided for given operating systems (OS) that exposes APIs into the OS. Embodiments herein would provide a new API exposed within the SDK.

In some embodiments, on the client device side, upon powering up the client device 120, the application stored therein checks to see if the client device 120 is connected to the SSID. If so, the client device 120 continues on processing without invoking WPS logic to the master device application. If the client device 120 is not connected to the SSID, in response to instructions from the master device application, utilizes the WPS API entry point to initiate WPS request cycle. The WPS request cycle is performed to pair the client device 120 to the AP SSID device 110 via the WPS logic. The WPS request cycle repeats a pre-set number of repeats until number of retries are exhausted or SSID is successfully paired via WPS logic. The WPS request cycle may also repeats for a pre-set amount of time until the amount of time is exhausted or is successfully paired via the WPS logic.

In various embodiments, communication between the master device 130 and the client device 120 may be established using any wired or wireless communication protocol. An example is to initialize the gateway as a Bluetooth device, and the master device 130 is able to pair with the client device 120 via the Bluetooth protocols. The master device 130 and client device 120 may then exchange data over a Bluetooth connection using respective APIs. Other protocols are application for establishing communication, for example, ThingWorx™, Z-wave™, ZigBee™, Wi-Fi™, etc. The master device application can get real time data from the client device 120 as to the WPS status and SSID paired and displaying the status to a user on master device's screen. The master device 130 never needs to communicate with AP SSID device 110 at all.

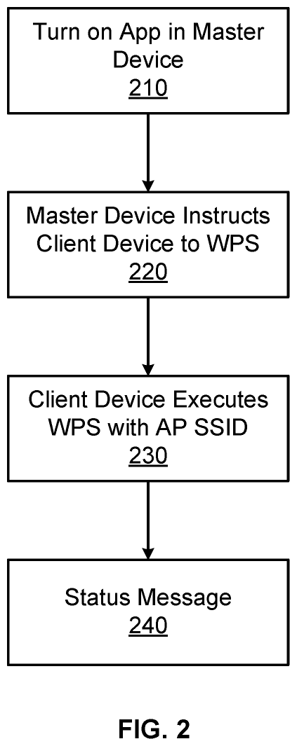

Referring to FIG. 2, FIG. 2 is a flow chart of an example method in accordance with the embodiments herein. Each of the steps may be performed sequentially or simultaneously unless otherwise stated. The steps may be performed by one or more of the master device 130, client device 120, and/or AP SSID device 110. For example, one or more processors of any of these devices may execute software stored in a memory in the form of instructions to perform the various steps shown below. While the below flowchart shows a specific order of steps, the order illustrated is not intended to be limiting and the steps may be performed in any order desired.

As illustrated, the application in the master device 130 is activated at, for example, step 210. The master device 130 instructs the client device 120 (e.g., via communication link 135) to execute the WPS at step 220. This can be accomplished, for example, by a user interfacing with the master device 130 which causes the master device 130 to transmit the instruction to “simulate the pressing of the WPS button or key” to the client device 120, in the manner as described above. At step 230 the client device 120 executes the WPS logic to establish a connection with the AP SSID device 110, for example via communication link 115. At step 240, the client device 120 communicates a status message to the master device 130 indicating the status of the connection between the client device 120 and the AP SSID device 110. The status message may be displayed on a display of the master device 130 for viewing by the user. The status message may indicate that the connection was successful, failed, or other status information that may be useful to the user.

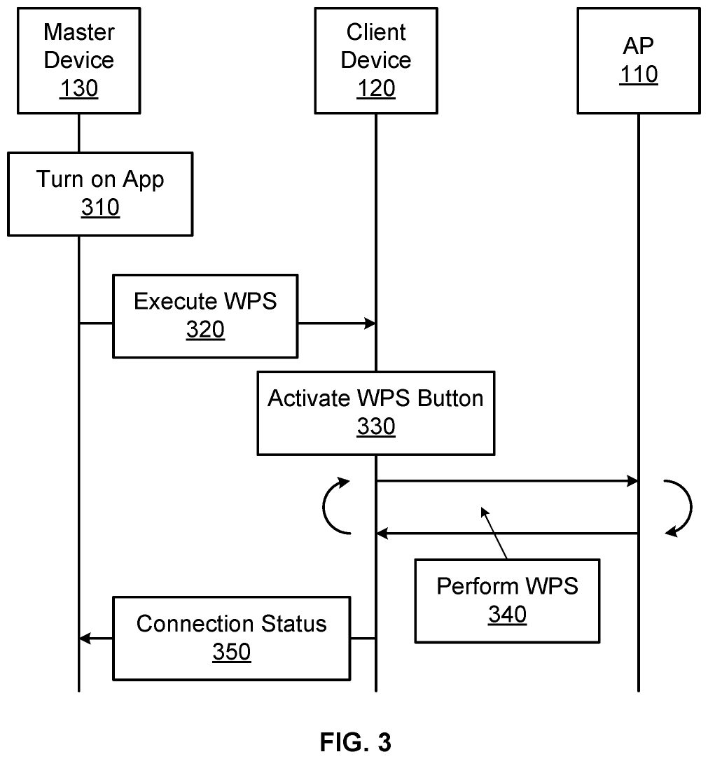

FIG. 3 is a schematic message diagram in accordance with the embodiments herein. Each of the processes may be performed sequentially or simultaneously unless otherwise stated. The processes may be performed by one or more of the master device 130, client device 120, and/or AP SSID device 110. For example, one or more processors of any of these devices may execute software stored in a memory in the form of instructions to perform the various steps shown below. While the below diagram shows a specific order of processes, the order illustrated is not intended to be limiting and the steps may be performed in any order desired.

As illustrated below, the application in the master device 130 is activated at, for example, step 310. The application at the master device 130 instructs (sends a message to) the client device 120 to execute the WPS at step 320. For example, a user of the master device 130 may initiate the transmission of the instruction via a user interface of the master device 130. For example, the transmitted message can be “simulate the pressing of the WPS button or key” at the client device 120, as described above. After the application at the client device 120 receives the instruction(s), at step 330 the application simulates the pressing of the WPS button (or key) in the manner described above. At step 340 the application at the client device 120 initiates and completes the WPS request cycle with the AP SSID device 110 in the manner described above. Then at step 350, the application at the client device 120 communicates a status message indicating the status of the connection between the client device 120 and the AP SSID device 110 to the master device 130.

Apple has provided a distinctly different solution, which also allows a Client device 120 to join an SSID without a password, but which has several disadvantages compared to the embodiments described herein. In the Apple solution, the Client device 120 requires special Apple hardware within the Client device 120. In the present embodiments, the Client device 120 does not require such proprietary hardware. In addition, the Apple solution requires the Apple iPhone or iPad to be joined to the S SID of interest such that the phone and Client device 120 must be on the same AP SSID.

Whereas embodiments herein provide for a secure local connection (wired or wireless) between the master device 130 and client device 120. The client device 120 may automatically enter into this mode to establish a connection at power up. If the SSID is already configured at power up, the connection with the master device 130 remains active such that the client device 120 application can receive instructions from the master device 130 independent of the WPS process. For example, if a customer wants to change SSIDs, then the master device 130 can instruct the client device 120 over the connection to re-enter into the WPS mode again and change SSID by simulating the pressing the WPS button (or key) on a new AP. The information sent to the client device 120 by the user via the master device 130 can be a request for the client device 120 to list all the SSIDs for example with their signal strength. This may not be part of the WPS process but may be valuable for selection of WPS devices, especially in the commercial world where there are many APs in the environment. None of these restrictions apply for the exchange of SSID and password information to the Client device 120 within this embodiment.

For an example, in an implementation of an embodiment, the Systech SysSCRIPT™ API is used for the protocol between an Apple® iPhone® (e.g., as an example master device 130 as used herein) and a Systech gateway (e.g., as an example of the Client device 120). The home router is the standard AT&T home router providing wireless and wired home Access Point SSID with password protection connected to the AT&T Fiber Optic network. The Systech gateway is the SysLINK™ SL-600 gateway with Wi-Fi and Bluetooth radios installed. The Bluetooth connection is provided by the SysSCRIPT™ drivers that have options to provide network socket IO connections, Bluetooth PAN connections, Bluetooth Low Energy (BLE), WEB interface (HTTPS,), etc. The API provides standard API subscribe, get, put, etc. support for communications. General commands or requests for information may be communicated across the standard JSON formatted protocol support by SysSCRIPT™. The configuration DB (database) within the gateway interacts with the drivers to define the actual communication path such as port number (3000, 4000, 5000, etc.) used as an example of one type of information the drivers use to determine the methods of communication to the master device 130. The advantage of using the BLE (Bluetooth low energy) process is the security and ease of paring between the client device 120 and the master device 130 provided by the BLE protocol. Within the JSON the property structure (which may contain topology) provides for status of communications but also status of events such as ack, unknown, etc. as command or property updates are processed. For example, SSID as a property may contain a status of connected, failed connection, etc. that can be communicated across the protocol channel from the gateway to the smartphone. A property of SSID may contain the action which could be join, cancel, abort, etc., that can be communicated from the smartphone to the gateway and the gateway responses with the status as it completes the action such as ack, processing, aborted, etc. General API and documentation for the Systech API is available via the WEB and SysSCRIPT™ applications. When using the BLE process and the client device 120 is a BLE-enabled device, special properties can be defined as part of the API which will provide secure information in a bi-directional communication path. While the example above is described in connection with a BLE connection, it will be appreciated that any wired or wireless communication protocol may be utilized for performing the WPS process in accordance with the above example.

The interactive WPS process within this embodiment is integrated into an application for the master device 130 (such as a phone or tablet) that allows the installer to select the WPS method of joining the AP SSID or select the SSID from a list of SSIDs and provide the password. The general process of selection of the SSIDs and entering the password can be standard but the interactive WPS (not to be confused with the interactive WPS of wps_cli within Linux OS) is added. As an example, when the application on the master device 130 is installed, entering the Gateway/client device 120 ID (serial number, etc.) provides security. The ability to enter multiple client devices are also a feature and can provide security in the multi-client device environment. In fact, using the remove feature, an entire ‘bank” of APs can be paired via WPS to many client devices within the commercial environment without physical access to the client device 120 installation.

Within installations containing many Client devices, the installer may install multiple Client devices from a single smartphone without leaving the physical location of the AP SSID device 110.

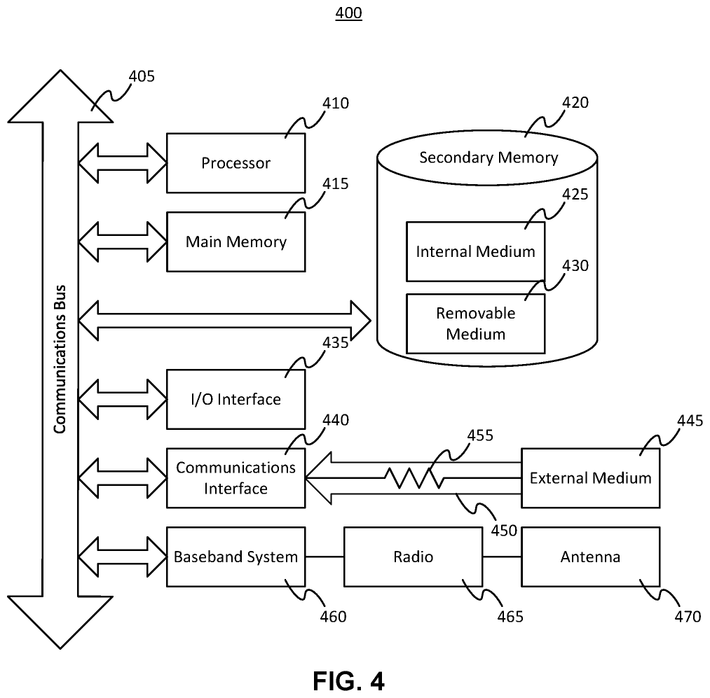

FIG. 4 is a functional block diagram illustrating an example wired or wireless processing device 400 that may be used in connection with various embodiments described herein. For example, system 400 may be implemented as the AP 110, master device 130 and/or client device 120 described above. System 400 can be a processor-enabled device that is capable of executing instructions in the form of software and executing data communication. Other computer systems and/or architectures may be also used, as will be clear to those skilled in the art.

System 400 preferably includes one or more processors, such as processor 410. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), an additional microprocessor or controller for dual or multiple processor systems, or a coprocessor. Such auxiliary processors may be discrete processors or may be integrated with the processor 410.

Processor 410 is preferably connected to a communication bus 405. Communication bus 405 may include a data channel for facilitating information transfer between storage and other peripheral components of system 400. Furthermore, communication bus 405 may provide a set of signals used for communication with processor 410, including a data bus, address bus, and control bus (not shown).

System 400 preferably includes a main memory 415 and may also include a secondary memory 420. Main memory 415 provides storage of instructions and data for programs executing on processor 410, such as one or more of the functions described above for the AP 110, master device 130 and/or client device 120. For example, it can store the client device application for a client device and the master device application for a master device. It should be understood that programs stored in the memory and executed by processor 410 may be written and/or compiled according to any suitable language, including without limitation C/C++, Java, JavaScript, Perl, Visual Basic, .NET, custom language for PIC or any microprocessor and the like. Main memory 415 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 420 may optionally include an internal memory (medium) 425 and/or a removable medium 430. Removable medium 430 is read from and/or written to in any well-known manner. Removable storage medium 430 may be, for example, a magnetic tape drive, a compact disc (CD) drive, a digital versatile disc (DVD) drive, other optical drive, a flash memory drive, etc.

Removable storage medium 430 is a non-transitory computer-readable medium having stored thereon computer-executable code (e.g., disclosed software modules) and/or data. The computer software or data stored on removable storage medium 430 is read into system 400 for execution by processor 410.

In alternative embodiments, secondary memory 420 may include other similar means for allowing computer programs or other data or instructions to be loaded into system 400. Such means may include, for example, an external storage medium 445 and a communication interface 440, which allows software and data to be transferred from external storage medium 445 to system 400. Examples of external storage medium 445 may include an external hard disk drive, an external optical drive, an external magneto-optical drive, etc. Other examples of secondary memory 420 may include semiconductor-based memory such as programmable read-only memory (PROM), erasable programmable read-only memory (EPROM), electrically erasable read-only memory (EEPROM), or flash memory (block-oriented memory similar to EEPROM).

System 400 may include a communication interface 440. Communication interface 440 allows software and data to be transferred between system 400 and external devices, networks, or other information sources. For example, computer software or executable code may be transferred to system 400 from a network server via communication interface 440. Examples of communication interface 440 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 400 with a network or another computing device. Communication interface 440 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 440 are generally in the form of electrical communication signals 455. These signals 455 may be provided to communication interface 440 via a communication channel 450. In an embodiment, communication channel 450 may be a wired or wireless network, or any variety of other communication links. Communication channel 450 carries signals 455 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules) is stored in main memory 415 and/or the secondary memory 420. Computer programs can also be received via communication interface 440 and stored in main memory 415 and/or secondary memory 420. Such computer programs, when executed, enable system 400 to perform the various functions of the disclosed embodiments.

In this description, the term “computer-readable medium” is used to refer to any non-transitory computer-readable storage media used to provide computer-executable code (e.g., software and computer programs) to system 400. Examples of such media include main memory 415, secondary memory 420 (including internal memory 425, removable medium 430, and external storage medium 445), and any peripheral device communicatively coupled with communication interface 440 (including a network information server or other network device). These non-transitory computer-readable mediums are means for providing executable code, programming instructions, and software to system 400.

In an embodiment that is implemented using software, the software may be stored on a computer-readable medium and loaded into system 400 by way of removable medium 430, I/O interface 435, or communication interface 440. In such an embodiment, the software is loaded into system 400 in the form of electrical communication signals 455. The software, when executed by processor 410, preferably causes processor 410 to perform the features and functions described above.

In an embodiment, I/O interface 435 provides an interface between one or more components of system 400 and one or more input and/or output devices. In various embodiments, the I/O interface 435 provides an interface between the components of system 400 and one or more devices or system external to the system 400 (e.g., devices communicating with system 400 over a network). Other example input devices include, without limitation, switches or other touch-sensitive devices, biometric sensing devices, and the like.

System 400 may also include wireless communication components that facilitate wireless communication over a data network and/or between devices using one or more of the protocols described above. The wireless communication components may comprise an antenna system 470, a radio system 465, and a baseband system 460 (collectively referred to as a radio transceiver). In system 400, radio frequency (RF) signals are transmitted and received over the air by antenna system 470 under the management of radio system 465. Radio system 465 can include a Bluetooth radio system and a Wi-Fi radio system.

Baseband system 460 also codes digital signals for transmission and generates a baseband transmit signal that is routed to the modulator portion of radio system 465. The modulator mixes the baseband transmit signal with an RF carrier signal generating an RF transmit signal that is routed to antenna system 470 and may pass through a power amplifier (not shown). The power amplifier amplifies the RF transmit signal and routes it to antenna system 470, where the signal is switched to the antenna port for transmission.

Baseband system 460 is also communicatively coupled with processor 410, which may be a central processing unit (CPU). Processor 410 has access to data storage areas 415 and 420. Processor 410 is preferably configured to execute instructions (i.e., computer programs, such as the disclosed example methods) that can be stored in main memory 415 or secondary memory 420. Computer programs can also be received from baseband processor 460 and stored in main memory 415 or in secondary memory 420, or executed upon receipt. Such computer programs, when executed, enable system 400 to perform the various functions of the disclosed embodiments. For example, data storage areas 415 or 420 may include various software modules.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A method for remote Wi-Fi protected setup for allowing a client device to join a Wi-Fi network via an access point (AP) without a user having access to the client device, the method comprising:
activating an application in a master device;
the activated application causing the master device to transmit instructions to the client device to initiate a Wi-Fi protected setup procedure;
in response to the instructions, executing, at the client device, the Wi-Fi protected setup procedure including establishing a connection with the AP; and
the client device communicating a status message to the master device indicating the status of the connection between the client device and the AP.

2. The method of claim 1 wherein the client device includes a button to initiate the Wi-Fi protected setup procedure and the instructions to the client device include instructions to an application on the client device to simulate via software the pressing of the button on the client device.

3. The method of claim 1 further comprising displaying the status message on a display of the master device.

4. The method of claim 3 wherein the status message indicates whether the connection was successful or failed.

5. A wireless client device, comprising:
a radio transceiver; and
one or more processors in communication with the radio transceiver and operable to receive instructions from a master to initiate a Wi-Fi protected setup (WPS);
in response to the instructions, executing the WPS including establishing a connection with an AP; and
the client device communicating a status message to the master device indicating the status of the connection between the client device and the AP.

6. The wireless client device of claim 5 wherein the client device includes a button to initiate the WPS and the instructions to the client device include instructions to the client device to simulate via software the pressing of the button on the client device.

7. The wireless client device of claim 6 further includes an application which when executed by the one or more processors creates an entry point at the WPS button that is branched into by an API, which can be called in response to the instructions from the master device and the one or more processors then execute the software that would otherwise be executed in response to the physical pressing of the button.

8. The wireless client device of claim 6 wherein the status message indicates whether the connection was successful or failed.

9. The wireless client device of claim 5 further comprising means for communicating with the master device with a first communication protocol and means for communicating with the AP with a second communication protocol.

10. A method for remote Wi-Fi protected setup (WPS) for allowing a client device having a WPS and a WPS button join a Wi-Fi network via an access point (AP SSID device) through the use of a master device without a user having access to the client device, the method comprising:
transmitting, from the master device, instructions to the client device to execute the WPS;
after the client device receives the instructions, simulating, at the client device, the pressing of the WPS button;
in response to the simulated pressing of the WPS button, the client device initiates and completes the WPS with the AP; and
transmitting from the client device to the master device a status message indicating the status of the connection between the client device and the AP.

11. The method of claim 10 wherein the client device initiates and completes the WPS with the AP comprises the client device executing the software that would otherwise be executed in response to the physical pressing of the WPS button.

12. The method of claim 10 further comprising displaying the status message on a display of the master device.

13. The method of claim 12 wherein the status message indicates whether the connection was successful or failed.

14. The method of claim 10 wherein the master device wirelessly communicates with the client device using the Bluetooth protocol.

15. The method of claim 14 wherein the client device wirelessly communicates with the AP device using a Wi-Fi protocol.
